(19) United States
(12) Patent Application Publication
(10) Pub. No.: US 2009/0239008 A1
(43) Pub. Date: Sep. 24, 2009

(54) LOW-SODIUM-OXIDE GLASS AND GLASS TUBE

(75) Inventor: Somchai Ovutthitham, Bangkok (TH)

Correspondence Address: BAKER & MCKENZIE LLP, Pennzoil Place, South Tower, 711 Louisiana, Suite 3400, HOUSTON, TX, 77002-2716, US

(73) Assignee: L. LIGHTING GLASS COMPANY LIMITED, Chachoengsao (TH)

(21) Appl. No.: 12/408,433

(22) Filed: Mar. 20, 2009

(30) Foreign Application Priority Data
Mar. 21, 2008 (TH) 0801001413

(51) Int. Cl. B32B 1/08; C03C 3/095

(52) U.S. Cl. 428/34.4; 501/64

(57) ABSTRACT

The low-sodium-oxide glass and glass tube, which have the following chemical components 55.0-70.0% SiO₂, 2.0-4.0% Al₂O₃, 3.0-7.0% MgO, and CaO, 2.0-5.0% SrO, 9.0-12.0% BaO, 2.0-4.0% Li₂O, 0-0.15% Na₂O, 12.0-14.0% K₂O, 0.1-0.6% CeO₂, (0.03%) Fe₂O₃, and (0.15%) SO₃, replace the borosilicate glass, with improvements to the physical properties and chemical durability, transmittance percentage controlled in the wave length interval at 313 nanometers (nm.), for maximum effectiveness for the light bulb manufacturing industry and also for other industries.

### TECHNICAL FIELD

This invention falls within a branch of chemistry relating to the manufacture of glass and glass tubes with low sodium oxide.

### BACKGROUND OF THE INVENTION

Technology and innovation on the manufacture of electrical appliances, equipment used for connection to computers, such as, flat-screen TVs, LCD, scanners, guiding equipment, all involve designs and developments into modern looks, taking into consideration convenience of users, who will be able to carry them to everywhere, and ease of move. Therefore, developments must be made with respect to appropriate size and weight. Glass tubes for the manufacture of backlights require the use of small-diameter glass. At present, there are manufacturers of glass tubes for the manufacture of backlights to accommodate the market of these electrical appliances, and they tend to expand themselves quickly.

Low-sodium-oxide glass tubes for the manufacture of light bulbs replace glass tubes for the manufacture of backlights, which are generally made of borosilicate glass with approx. 10-20 percent boric oxide. This makes it difficult for glass to melt and the cost of production is high. In addition, there is an important factor regarding the fairly low coefficient of expansion, α, of borosilicate glass when heated. As a result, when it is used by the light bulb manufacturing industry, it must select a metal wire for sealing with the coefficient of expansion, α, close to the fairly low coefficient of expansion, α, of borosilicate glass. Those currently used are tungsten, molybdenum and kovar wires, which are at somewhat high prices. Therefore, in the invention of low-sodium-oxide glass tubes for the manufacture of light bulbs, the coefficient of expansion, α, of the glass when heated has been adjusted and developed to a value close to that of a dumet wire, which is of lower cost. As a result, light bulb manufacturing business operators also incur lower cost. And through the preparation of chemical components of low-sodium-oxide glass tubes for the manufacture of light bulbs having regard to the glass softening point (Ts), which is lower than that of the borosilicate glass, and the working temperature (Tw), which is higher than that of the borosilicate glass, the working range becomes wider than that of the borosilicate glass by at least 450° C., which is one of the very important properties.

The invention of low-sodium-oxide glass tubes for the manufacture of light bulbs adds the improvement of the glass quality for the absorbance of light waves in the range of ultraviolet rays (UV). It is known that the UV light wave is dangerous, and in the invention the wave length at 313 nanometers (nm.) will be controlled through the application of cerium oxide (CeO₂).

The significant advantage of low-sodium-oxide glass tubes for the manufacture of light bulbs is the glass tube durability with chemical resistance. There has been a development of the ratio of soda ash, which yields the value of sodium oxide (Na₂O); and potassium carbonate, which yields the value of potassium oxide (K₂O); barium carbonate, which yields the value of barium oxide (BaO), and other chemical components that have environmental awareness without hazardous heavy metals, such as, lead (Pb), arsenic (As), cadmium (Cd), mercury (Hg), hexavalent chromium (CrVI), polybrominated biphenyl (PBB), polybrominated diphenyl ether (PBDE), etc.

### SUMMARY OF THE INVENTION

An invention concerning low-sodium-oxide glass and glass tubes to replace borosilicate glass results in lower cost of production and emphasizes on an adjustment to quality for the absorbance of light in the range of ultraviolet rays (UV). The wave length will be measured at 313 nanometers (nm.). This invention comprises an adjustment to the durability of glass and glass tubes so that they have chemical resistance and physical properties through the selection of chemical components which are not hazardous to the environment. This is also a technique suitable to glass and glass tubes for the light bulb manufacturing industry and for other industries.

### DETAILED DESCRIPTION

This invention results from the outcome of a study aiming at the finding of glass tubes with low-sodium-oxide for the manufacture of backlights to replace borosilicate glass so that the cost of production becomes lower and that adjustments and improvements are made to the quality for the absorbance of ultraviolet rays (UV). It is known that this UV light wave is harmful to components assembled in flat screen televisions, LCD-TFT television screens, flat screen PCs and laptops, scanners and navigation systems. According to the result of these studies in conjunction with the background as a manufacturer of both soda-lime glass and lead-free glass tubes for light bulbs, the inventor has discovered that it could adjust and improve the property regarding the transmittance of ultraviolet rays (UV) for the absorbance of the light wave controlled in the range of a 313 nanometer (nm.) wavelength by admixing a 0.1-0.6% quantity of cerium oxide (CeO₂), causing the light transmittance value to be less than 2.0%. In addition, the value of glass durability must be taken into consideration with a development of soda ash, which yields the value of sodium oxide (Na₂O) less than 0.15%, thereby resulting in good chemical resistance; and potassium carbonate, which yields the value of potassium oxide (K₂O)=12-14%; lithium carbonate (Li₂CO₃), which yields the value of lithium oxide (Li₂O)=2-4%; barium carbonate, which yields the value of barium oxide (BaO)=9-12%; strontium carbonate, which yields the value of strontium oxide (SrO)=2-5%; magnesium carbonate, which yields the value of magnesium oxide (MgO); and calcium carbonate, which yields the value of calcium oxide (CaO)=3-7%.

The invention of low-sodium-oxide glass tubes for the manufacture of light bulbs has improved and developed the coefficient of expansion, α, of glass when heated so that it is close to that of dumet wires, which are of lower cost. The alpha value (α) yielded will be around (92.0-99.0)×10⁻⁷/° C. And through the preparation of chemical components of low sodium oxide for the manufacture of backlights, having regard to the value of glass flexibility or softening (softening point), which is lower than that of borosilicate glass, i.e. the borosilicate glass softening point is >700° C. and the softening point of this low-sodium-oxide glass invented is=670-700° C. and its working point, Tw, is higher than that of the borosilicate glass, its working range becomes wider than that of the borosilicate glass by at least 450° C., which range is beneficial to the light bulb manufacturing industry.

This invention contains a general description. It will be better understood by reference to special examples included herein only for the purpose of indication, and they are not considered limitations of the invention unless otherwise explained.

The invention of low-sodium-oxide glass and glass tubes comprise chemical components as follows: 55.0-70.0% SiO₂, 2.0-4.0% Al₂O₃, 3.0-7.0% MgO and CaO, 2.0-5.0% SrO, 9.0-12.0% BaO, 2.0-4.0% Li₂O, 0-0.15% Na₂O, 12.0-14.0% K₂O, 0.1-0.6% CeO₂, (0.03%) Fe₂O₃, and (0.15%) SO₃.

### EXAMPLE 1

Prepare chemical components to calculate the quantity of raw materials to be mixed together. The raw materials are represented by percentage weight as follows:

| Components | Percent |
|---|---|
| SiO₂ | 62.80 |
| Al₂O₃ | 4.00 |
| MgO/CaO | 3.40 |
| SrO | 5.00 |
| BaO | 9.00 |
| Li₂O | 2.80 |
| Na₂O | 0.05 |
| K₂O | 12.70 |
| CeO₂ | 0.10 |
| Fe₂O₃ | 0.03 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Coefficient of expansion, Alpha | 93.1 |
| (30-380° C. × 10⁻⁷/° C.) | |
| Density (g/cc) | 2.656 |
| Glass transition, Tg (° C.) | 516 |
| Annealing point, Ta (° C.) | 569 |
| Softening point, Ts (° C.) | 692 |
| Working point, Tw (° C.) | 1191 |

From the result obtained, the working range will be 499° C.

Examine the chemical durability by the method under JIS R3502 (Na₂O mg), with the use of an autoclave at 121° C. for a period of 60 minutes. The concentration (R₂O mg/l) is as follows:

| | |
|---|---|
| Na₂O | <0.5 |
| K₂O | 10.1 |
| Li₂O | 2.7 |

### EXAMPLE 2

Prepare chemical components to calculate the quantity of raw materials to be mixed together. The raw materials are represented by percentage weight as follows:

| Components | Percent |
|---|---|
| SiO₂ | 60.15 |
| Al₂O₃ | 3.00 |
| MgO/CaO | 5.00 |
| SrO | 5.00 |
| BaO | 11.00 |
| Li₂O | 2.20 |
| Na₂O | 0.15 |
| K₂O | 13.00 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Coefficient of expansion, Alpha | 93.3 |
| (30-380° C. × 10⁻⁷/° C.) | |
| Density (g/cc) | 2.726 |
| Glass transition, Tg (° C.) | 531 |
| Annealing point, Ta (° C.) | 585 |
| Softening point, Ts (° C.) | 703 |
| Working point, Tw (° C.) | 1183 |

From the result obtained, the working range will be 480° C.

### EXAMPLE 3

Prepare chemical components to calculate the quantity of raw materials to be mixed together. The raw materials are represented by percentage weight as follows:

| Components | Percent |
|---|---|
| SiO₂ | 61.85 |
| Al₂O₃ | 3.00 |
| MgO/CaO | 5.00 |
| SrO | 3.00 |
| BaO | 11.00 |
| Li₂O | 2.50 |
| Na₂O | 0.15 |
| K₂O | 13.00 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Coefficient of expansion, Alpha | 92.3 |
| (30-380° C. × 10⁻⁷/° C.) | |
| Density (g/cc) | 2.68 |
| Glass transition, Tg (° C.) | 523 |
| Annealing point, Ta (° C.) | 578 |
| Softening point, Ts (° C.) | 699 |
| Working point, Tw (° C.) | 1176 |

From the result obtained, the working range will be 477° C.

### EXAMPLE 4

Prepare chemical components to calculate the quantity of raw materials to be mixed together. The raw materials are represented by percentage weight as follows:

| Components | Percent |
|---|---|
| SiO₂ | 61.35 |
| Al₂O₃ | 3.00 |
| MgO/CaO | 5.00 |
| SrO | 3.00 |
| BaO | 11.00 |
| Li₂O | 3.00 |
| Na₂O | 0.15 |
| K₂O | 13.00 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Coefficient of expansion, Alpha | 95.6 |
| (30-380° C. × 10⁻⁷/° C.) | |
| Density (g/cc) | 2.703 |
| Glass transition, Tg (° C.) | 511 |
| Annealing point, Ta (° C.) | 559 |
| Softening point, Ts (° C.) | 685 |
| Working point, Tw (° C.) | 1150 |

From the result obtained, the working range will be 465° C.

Examine the chemical durability by the method under JIS R3502 (Na₂O mg) using an autoclave at 121° C. for a period of 60 minutes. The concentration, R₂O mg/l, is as follows:

| | |
|---|---|
| Na₂O | <0.5 |
| K₂O | 10.1 |
| Li₂O | 2.8 |

### EXAMPLE 5

Prepare chemical components to calculate the quantity of raw materials to be mixed together. The raw materials are represented by percentage weight as follows:

| Components | Percent |
|---|---|
| SiO₂ | 61.35 |
| Al₂O₃ | 2.00 |
| MgO/CaO | 5.00 |
| SrO | 4.00 |
| BaO | 11.00 |
| Li₂O | 3.00 |
| Na₂O | 0.15 |
| K₂O | 13.00 |
| CeO₂ | 0.50 |

The chemical components above will be applied to the calculation of the proportion of raw materials required to be mixed and melted into glass at the temperature of 1450° C. in a lab furnace. When a specimen has been obtained, steps are then taken to examine its physical properties. The result obtained is as follows:

| Physical Properties | Results Obtained |
|---|---|
| Coefficient of expansion, Alpha | 99.1 |
| (30-380° C. × 10⁻⁷/° C.) | |
| Density (g/cc) | 2.71 |
| Glass transition, Tg (° C.) | 510 |
| Annealing point, Ta (° C.) | 559 |
| Softening point, Ts (° C.) | 680 |
| Working point, Tw (° C.) | 1140 |

From the result obtained, the working range will be 460° C.

Examine the chemical durability by the method under JIS R3502 (Na₂O mg) using an autoclave at 121° C. for a period of 60 minutes. The concentration, R₂O mg/l, is as follows:

| | |
|---|---|
| Na₂O | <0.7 |
| K₂O | 12.9 |
| Li₂O | 3.6 |

From the abovementioned example, it was found that the chemical durability yielded the concentration of Na₂O<1.0 mg/l.

Bring the low-oxide-glass and glass tube from this invention with the thickness of 1.0 mm. max to test the percentage of transmittance of ultraviolet rays (UV) so that it the light wave absorbance is controlled in the wave length interval of 313 nanometers (nm.). It was found that the transmittance value<2.0%.

I claim:

1-6. (canceled)

7. A low-sodium-oxide glass comprising silicon dioxide (SiO₂) from about 55.0 to about 70.0 wt %; aluminum oxide (Al₂O₃) from about 2.0 to about 4.0 wt %; barium oxide (BaO) from about 9.0 to about 12.0 wt %; a mixture of magnesium oxide (Mg) and calcium oxide (CaO) from about 3.0 to about 7.0 wt %; sodium oxide (Na₂O) from about 0 to about 0.15 wt %; potassium oxide (K₂O) from about 12.0 to about 14.0 wt %; lithium oxide (Li₂O) from about 2.0 to about 4.0 wt %; cerium oxide (CeO₂) from about 0.1 to about 0.6 wt %; strontium oxide (SrO) from about 2.0 to about 5.0 wt %; and iron oxide (Fe₂O₃) less than about 0.03 wt %.

8. The low-sodium-oxide glass of claim 1 having a softening point between about 670 to about 700° C.

9. The low-sodium-oxide glass of claim 1 having a working point (Tw) from about 1140 to about 1195° C.

10. The low-sodium-oxide glass of claim 1 having a working point (Tw) range from about 460 to about 500° C.

11. The low-sodium-oxide glass of claim 1 having less than about 1.0 mg/l Na₂O.

12. The low-sodium-oxide glass of claim 1 having a coefficient of expansion, α, from about 92.0×10⁻⁷/° C. to about 99.0×10⁻⁷/° C.

13. A low-sodium-oxide glass tube comprising the composition of claim 1.

14. The low-sodium-oxide glass tube of claim 13, wherein the tube is used in the manufacture of light bulbs.

15. The low-sodium-oxide glass tube of claim 14, wherein the light bulb is used in the manufacture of backlights.

16. The low-sodium-oxide glass tube of claim 13 having a thickness less than about 1.0 millimeter (mm.).

17. The low-sodium-oxide glass tube of claim 13 having a percentage of transmittance of ultraviolet rays of less than about 2.0% controlled in the wave length interval at 313 nanometers (nm).
